(19) United States
(12) Patent Application Publication
(10) Pub. No.: US 2003/0115115 A1
(43) Pub. Date: Jun. 19, 2003

(54) Private exchange catalog system and methods

(76) Inventor: Norman Ken Ouchi, San Jose, CA (US)

Correspondence Address: NORMAN KEN OUCHI, 20248 VIEW CREST CT, SAN JOSE, CA, 95120, US

(21) Appl. No.: 09/939,453

(22) Filed: Aug. 25, 2001

(51) Int. Cl. G06F 17/60

(52) U.S. Cl. 705/27; 705/29

(57) ABSTRACT

This invention is related to electronic information transfer between trading partners and more particularly to the conversion and validation of item identifiers, part numbers, in documents that describe a manufactured product.

In the present invention, a private exchange catalog provides the description of an item and the item identifier, the part number, as represented in the sets of part numbers of each trading partner. The catalog is used for validation and processing of the Approved Manufacture List, a cross reference between a buyers part number and a supplier part number, and for part number conversion and validation of the Bill of Material, a list of part numbers and quantities for a product, and the AML as these documents are transferred between the trading partners. Methods for using and maintaining the private exchange catalog are provided.

### CROSS-REFERENCE TO RELATED APPLICATIONS

Process & Transformation Private Exchange, Ouchi, N.K., Filed on Aug. 20, 2001

### STATEMENT REGARDING FEDERALLY SPONSORED RESEARCH OR DEVELOPMENT

Not Applicable

### FIELD OF THE INVENTION

This invention is related to electronic information transfer between trading partners and more particularly to the conversion and validation of item identifiers, part numbers, in documents that describe a manufactured product.

### BRIEF SUMMARY OF THE INVENTION

In the present invention, a private exchange catalog provides the description of an item and the item identifier, the part number, as represented in the sets of part numbers of each trading partner. The catalog is used for validation and processing of the Approved Manufacture List, a cross reference between a buyers part number and a supplier part number, and for part number conversion and validation of the Bill of Material, a list of part numbers and quantities for a product, and the AML as these documents are transferred between the trading partners. Methods for using and maintaining the private exchange catalog are provided.

### BACKGROUND OF THE INVENTION

A product is produced by combining a set of items: components or raw materials. The list of items and the quantity of each item required to produce a unit of the product is called the Bill of Materials or BoM. A familiar example of a BoM is the list of ingredients (items) and ingredient quantities of a cooking recipe. A cooking recipe lists the ingredients by description, e.g. sugar, salt, flour, etc.

TABLE 1
BoM for Cookie Recipe

| Ingredient (Item) | Quantity | |
|---|---|---|
| Sugar | 1 | cup |
| Salt | 1 | teaspoon |
| Flour | 2 | cups |

However, most organizations that develop products do not use the item description directly but assign to each item a part number that uniquely identifies the item in a BoM or other documents in which the item needs identification. Thus, a BoM is a list of part numbers with the quantity of each part number required to produce the product. Since the assignment of a part number to an item is arbitrary, each organization has made assignments for the items of interest to them. Within an organization, the item and part number association is self-consistent. That is, when done properly, there is a one-to-one mapping of the items to part numbers such that a part number uniquely identifies an item and an item has one part number. However, the set of part numbers and the assignments to items of one organization usually have no relationship with the set of part numbers and assignments to items of another organization. An item assigned a part number in one organization may not be assigned the same part number in another organization. That is, an item, for example sugar, may be assigned the part number 1234 in Organization A and assigned part number BX317 in Organization B. In Organization A, 1234 on a BoM means sugar just as in Organization B, BX317 means sugar. However, in Organization A the part number BX317 may be meaningless or may be the part number for something else quite different from sugar. The relationships between data elements may be illustrated using a Structured Query Language, SQL, Table. Data fields may be retrieved, updated, or inserted using the SQL commands. The names of the SQL data fields are in bold font, the SQL key words are in CAPITAL FONT, and the parameters are in parenthesis “ ”. Table 2 illustrates an Organization A Part Number to Item SQL Table. In Table 2, the SQL query SELECT Item Description FROM Organization A Part Number to Item Table WHERE Organization A Part Number=“1234” would return “Sugar”.

TABLE 2
Organization A Part Number to Item Table

| Organization A | |
|---|---|
| Part Number | Item Description |
| 1234 | Sugar |
| 1235 | Salt |
| 1236 | Flour |

The BoM for a Cookie Recipe with Organization A part numbers could be illustrated as:

TABLE 3
Cookie Recipe BoM with part numbers

| Organization A | | | |
|---|---|---|---|
| Part Number | Quantity | | Item Description |
| 1234 | 1 | cup | Sugar |
| 1235 | 1 | teaspoon | Salt |
| 1236 | 2 | cups | Flour |

If an organization does not manufacture sugar, then sugar must be purchased from a supplier. The Sugar Supplier has a set part numbers to identify their products and the items needed to manufacture them. To extend the example, the Sugar Supplier assigned the part number S789 for a 50 pound bag of sugar and publishes the mapping of part numbers to items in a catalog. A Sugar Supplier catalog entry could appear as:

TABLE 5
Sugar Supplier Catalog

| Supplier | |
|---|---|
| Part Number | Item Description |
| S789 | Sugar - 50 pound bag |
| S795 | Sugar - 100 pound bag |

Organization A accesses the Sugar Supplier Catalog, using SELECT Supplier Part Number WHERE Item Description=“Sugar—50 pound bag”, returns Supplier Part Number=“S789”. Using the catalog to determine the part number for a 50 pound bag of sugar, Organization A or Organization B can order the 50 pound bag of sugar from the Sugar Supplier by ordering one unit of S789. The assignment of part numbers to items within an organization and ordering items using the part number of the supplier has been the common mode of operation for industries. Organization A can create Table 5 to translate the Organization A part number to the supplier part number:

TABLE 5
Organization A Approved Manufacturer List Table

| Organization A | | Supplier |
|---|---|---|
| Part Number | Supplier Name | Part Number |
| 1234 | Sugar Supplier | S789 |

Organization A queries using SELECT Supplier Name; Supplier Part Number WHERE Organization A Part Number=“1234” in Table 5 results in Supplier Name=“Sugar Supplier”; Supplier Part Number=“S789”. Note that both the supplier and the part number must be identified since the part number has meaning only for that supplier. Table 5 is typically called the Approved Manufacturer List, AML. Organization A creates and maintains the AML using the catalog published by Sugar Supplier. Note that Organization A can change the relationship of the part number 1234 to the supplier number S789 without involving the supplier. For example, Organization A can change the size of the bag of sugar to 100 pounds for ordering by changing their AML by finding the correct entry in the catalog for Sugar-100 pound bag with part number S795. The Organization A materials planning system parameter for the cups of sugar per bag needs to change to reflect the new amount of sugar per bag. If Organization A had cookie making equipment that used 50 pound bags but changed to equipment that uses 100 pound bags, this is how they would change the internal information so that orders to Sugar Supplier would order 100 pound bags. The AML identifies the supplier and the part number of the “orderable” item. Organization A cannot order “sugar” but sugar in specific bag sizes and each bag size has a distinct part number. The AML part number field contains the part number of a bag of sugar of specific size. The supplier may also have different part numbers for the same 50 pound bag of sugar because of the region or plant of manufacture. The AML must also reflect these differences and carry the part number that will order exactly what is needed. Programs and systems now process the orders and these need accurate input.

People can tolerate a significant error rate in information and still get the right output. Systems cannot. An error in transcribing a part number from the supplier catalog to the AML or an error in the supplier name can result in the delivery of the wrong item. The error can then be corrected manually. When commerce ran at a slower pace, manual error correction was tolerable. However, the level of change has increased dramatically and organizations that can accommodate change have a significant competitive advantage.

Organization B can have a similar AML to match BX317 to Sugar Supplier part number S789 for a 50 pound bag.

Organization A may add another supplier of sugar. The added supplier, “New Sugar” and the supplier part number for a 50 pound bag of sugar “XS-50” is added to the AML as another row as illustrated in FIG. 6. For Organization A, part number 1234 means a 50 pound bag of sugar and can be supplied by either Sugar Supplier or New Sugar. The bags of sugar are treated as interchangeable and may be stocked in the same warehouse location.

TABLE 6
Organization A Approved Manufacturer List SQL Table

| Organization A | | Supplier |
|---|---|---|
| Part Number | Supplier Name | Part Number |
| 1234 | Sugar Supplier | S789 |
| 1234 | New Sugar | XS-50 |

In addition, some organizations have a relationship with the supplier such that they can order using the organization's part number. That is, Organization A can arrange to order a bag of sugar from the Sugar Supplier using the part number 1234. The sugar supplier internally maps to its part number S789. This mechanism requires manual processing by both buyer and seller to cooperatively establish the part number translation tables and works well when the ordering process is static. However, in the electronics industry and others, the velocity of change is surfacing the shortcomings of the processes that work in simple, slow, low volume change environments.

If the Sugar Supplier accepts the part number of an organization, it can have a table similar to the AML except that it would need to identify the customer and associated the part number. The Sugar Supplier can have an SQL table, called a Customer Part Number List, that appears as:

TABLE 7
Customer Part Number List Table

| | Customer | Sugar Supplier |
|---|---|---|
| Customer Name | Part Number | Part Number |
| Organization A | 1234 | S789 |
| Organization B | BX317 | S789 |

The Sugar Supplier queries using SELECT Sugar Supplier Part Number WHERE Customer Name=“Organization A” and Customer Part Number=“1234” which returns Sugar Supplier Part Number=“S789”

Organization A can have a table to identify the supplier of an item to whom the order with the Organization A part number can be used to identify the item. The Organization A table can appear as:

TABLE 8
Approved Vendor List SQL Table

| Organization A | |
|---|---|
| Part Number | Supplier Name |
| 1234 | Sugar Supplier |

Organization A queries using Organization A Part Number=“1234” Which returns Supplier Name=“Sugar Supplier” and orders from Sugar Supplier using the Organization A part number, 1234. This table is commonly called the Approved Vendor List, AVL. The Sugar Supplier creates and maintains the Customer Part Number List by having the customer send a description of the item with the customer part number and Sugar Supplier matches the description with their catalog to find their part number. Note that creating and maintaining both tables requires the cooperation of both the customer and supplier. If Organization A wants to change sugar bag size, it must send the description of item to the supplier with the Organization A part number so the supplier can create the correct entry in the Customer Part Number List Table, then the item may be ordered using the Organization A part number. The combination of the Organization A Approved Vendor List Table and the Sugar Supplier Customer Part Number List Table are in effect the AML distributed between the trading partners. The discussion on the AML can be applied to the AvL except that the supplier part number entry must be updated in the supplier Customer Part Number List rather than the AML.

In the electronics industry, many companies, called Original Equipment Manufactures or OEM, have multiple design groups that are developing different product lines. However, many of the products use items that are produced by the same supplier. It is desirable for the design groups to coordinate the part number assignment so that as a company the common items each have the same company part number independent of the design organization. Illustrated in FIG. 1 are three OEM design groups, a supplier and supplier catalog, and an OEM Design Catalog. Each OEM organization has their own AML shown as AML-A, AML-B, and AML-C. The OEM has a common item OEM Design Catalog that provides the description and part numbers for items that have been assigned part numbers by the OEM. The design groups are to search the OEM Design Catalog to find an item to use in their products. If an item is not found, the design group searches the catalogs of suppliers to find an item that will provide the function desired. The new item is added to the OEM Design Catalog and assigned a part number. This is how the OEM Design Catalog is supposed to work. However, the process does not work perfectly and there are errors and omissions in the OEM Design Catalog. The design organizations find the overhead of the OEM Design Catalog as an impact to the product development schedule, the items are hard to find, it takes time and effort to look for each item, adding an item takes time and effort, etc. People entered the supplier part numbers and manual entry introduces errors. The supplier part numbers change as items are revised and given new part numbers and the OEM catalog and AML are not updated. Each design group may control the AML for new products and keep their own local catalog. They would purchase the items for building the prototypes and release the design and the new items, part numbers, and AML for inclusion in the OEM Design Catalog. The local design group AML and part numbers may have conflicts with the OEM Design Catalog. As an example, an item has a part number and an AML in the OEM Design Catalog. The AML has three different suppliers each with a corresponding part number. In testing the prototype, the local design group finds that the item from one supplier is much better than the other two so they remove the other two companies from their local AML. The local AML is now different from the AML in the OEM Design Catalog. The OEM has the choice of removing the two suppliers from the OEM Design Catalog AML (and all design groups using the new AML) or creating a new part number for the item with the different AML. If not resolved, the product might be manufactured with an item from a supplier that was not listed in the local AML of the design group. People are needed to identify the conflicts and resolve the issues. When product development schedules were measured in months and years, the time to find and resolve these issues were not a problem. However, product development schedules are measured in days and weeks and the errors and delays of manual processing are becoming apparent.

Many OEM are turning to companies that provide manufacturing services called, Electronic Manufacturing Service or EMS, to build their products as illustrated in FIG. 2. The OEM provides the documents that describe the product to the EMS to build the prototype, the early manufacturing units, then volume build in manufacturing sites in several geographies. -The OEM documents include the Computer Aided Design, CAD, files, the BoM, and the AML. All of the documents are in the part number set of the design group. The EMS has multiple sites that have focused responsibilities: sites for rapid prototype production, sites for medium volume production, and sites for high volume production. The sites are in different geographies: North America, South America, Asia, Europe, etc. In FIG. 2, OEM Design Group A releases product documentation to EMS Site A, EMS Site B, and EMS Site C. Included in the documents are the OEM Design Group A AML and BoM. Each EMS site maps an OEM part number to an EMS site part number. Each site may have a different mapping mechanism so an OEM item may have a very different part number at each EMS site. Each EMS site must map the OEM part numbers in BoM and AML to the EMS site part number so that the BoM and AML are tailored to the EMS site. In addition, the AML is further tailored to match the EMS site equipment requirements. Each site has automated equipment that is suited for the responsibility: prototype, medium volume, or high volume. The equipment may be from different manufacturers and each may have different carrier requirements. The items are fed into the automated equipment using “carriers” that are part of the product delivered by the supplier. The carrier type must match the requirement of the equipment. An item delivered on carrier type A has a different supplier part number from the same item delivered on carrier type B. In the sugar example, the 50 pound bag has a different part number from the 100 pound bag. Both contain sugar but each bag size is a different carrier and has a different supplier part number. An electronic component may have a variety of tape and reel carriers, a variety of tray carriers, etc. and each has a different supplier part number. The supplier may have different part numbers based on their region of manufacture. The bottom line is that the supplier part number provided by the OEM in the AML may have errors due to the issues of the differences between OEM and local AML in the development process and even if accurate, may have to be changed to a different part number because of the EMS manufacturing equipment and manufacturing region. Each EMS site has an AML for the product released by OEM Design Group A derived from the OEM Design Group A AML but modified to meet the local requirements of the EMS site. The EMS sites use the Supplier Catalog to validate the supplier part number for an item and to find the part number in that geography for the item on the carrier required for the EMS site equipment.

The EMS sites place orders directly to the supplier using the part number in the EMS site AML. Each AML may have some variation of the supplier part number, or may be really an AVL where the OEM or the EMS site part number is used. The supplier may see orders with different part numbers for the same item. An EMS site with multiple OEM customers each with their own part numbers in the orders may be ordering the same item using multiple part numbers. The EMS with multiple sites may be ordering the same item from the same supplier with different part numbers on behalf of an OEM. The different part numbers within an EMS site and the separate order streams from each EMS site makes viewing the aggregated purchases impossible. The EMS cannot negotiate effective volume contracts without this kind of information. The EMS may be canceling an order for an item and at the same time asking for expedited delivery of the same item. The root cause of these problems is the lack of cross correlation between part numbers and the independent order stream from each EMS site.

OEM Design Group B may also release a product to EMS Site C. As discussed above, the AML from OEM Design Group B may have some variation from the AML provided by OEM Design Group A. The variations must be identified and resolved in order for EMS Site C to build products for both design groups.

Distributors and secondary suppliers complicate the issue in that they may rename the item with their own part number system. The AML structure can be used to order the item from a distributor by treating them as a “manufacturer” in the AML where the manufacturer part number is the distributor's part number.

The EMS may be buying a many items that are the same for several OEM's but not capable of taking advantage of the aggregated volume since all of the items have different part numbers. It is to the EMS advantage to know exactly what is ordered and to control the part number. A “global” translation table for part numbers would be desirable. A manual process is error prone and adds delay but some EMS have created internal organizations to create and maintain translation tables. Some of the items, many low cost and readily available called commodities, are used by many of the OEM. The EMS would like a mechanism that lets them manage this set of the items as a different class of items, commodity items with a different part number set separate from the part numbers assigned by the OEM.

The AML and BoM may be combined in one set of files or release or these may be released at separate times and not connected. The BoM may have items that are not on the AML where the OEM expects the EMS to figure out how to order these items. This is typical for commodity items. There may be items in the AML that are not in the set of BoM's sent to the EMS. The OEM keeps a master AML for all of the purchasable items and may send the complete master AML with each assembly. Or the OEM may just send the master AML on a periodic basis. The EMS must keep a one to one map of the components in the OEM AML for all of the items that are in the BoM's that the EMS is building for the OEM. And the EMS must keep the manufacturer part numbers correct for the specific line configurations used to build each product. It is highly possible that an OEM will have one entry in its AML and the EMS have several because the product is manufactured on two or more assembly lines with different carrier requirements.

The EMS has focused production sites. Each site has materials planning systems that order material that meets the requirements of the site manufacturing equipment and the local supply base. The AML in the EMS site must be tailored to meet these requirements.

In general, the AML as provided by the OEM cannot be directly used by the EMS site but must be changed. In addition, the site is manufacturing for several OEM and cannot use the OEM part number so maps to an internal EMS part number set. An item in the AML and BoM must have matching part numbers so both AML and BoM must be adapted to the site requirements. However, the EMS desires a “global” view of all of the AML and BoM so that the OEM has a single interface to the EMS, the EMS can release the OEM product to any of the EMS sites for production, the EMS can see the global production for an OEM and the global purchasing of items from suppliers, global view of items on order and in inventory even if each site has a different part number for the item.

The AML and BoM are processed when the OEM requests a quote for manufacturing services, when the prototypes are built, when manufacturing is started in another site, and when changes are made in the product. AML and BoM processing are essential for the manufacture of the product.

The issues of development and manufacturing related to the Approved Manufacturing List, AML, and the Bill of Material, BoM. Errors in the AML due to:

1. Manual entry of the part number,

2. Changes in the part number due to supplier catalog changes, etc.

3. Supplier name spelling not consistent with the spelling by EMS

4. Difference between OEM AML and local AML of the design group requiring the change in the AML or use of a new part number with its own AML

5. Manufacturing equipment or regional supply base differences

In addition:

1. BoM items without an AML that the OEM expects the EMS to resolve,

2. The BoM contains items that are “commodities” that are assigned a different part number set.

3. The AML released by the OEM may be a master AML with part numbers that are not used in the products manufactured by the EMS for the OEM.

4. AML and BoM are translated to the EMS site part number set.

5. EMS desires a global view of items on order, in inventory, purchasing from suppliers etc.

6. EMS desires a single interface to the OEM from which the product can be released for production to any EMS site.

Some of these requirements are fulfilled with manual processes with some systems assistance. However, these are error prone and add delay to the fast moving changes demanded by commerce. Extending the current manual processes with automation will not work because the manual processes only focus on one or two aspects of the issues and do not account for the interrelationship between the processes. A new integrated methodology is required.

### BRIEF DESCRIPTION OF DRAWINGS

FIG. 1 illustrates three OEM Design Groups with a Design Catalog using items from a Supplier with a Supplier Catalog.

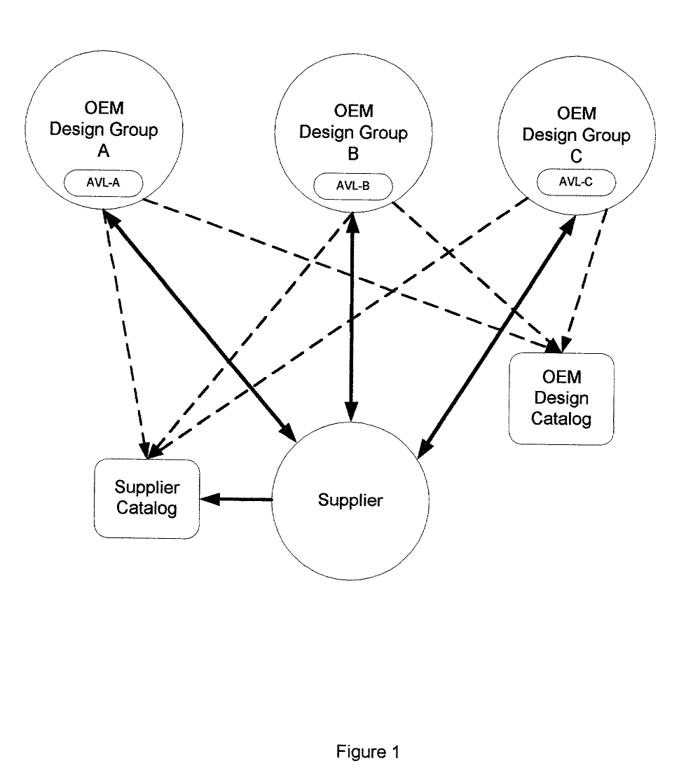

FIG. 2 illustrates two OEM Design Groups with manufacturing services provided by three sites of an EMS purchasing items from a Supplier.

FIG. 3 illustrates a Private Exchange Catalog System with the two OEM Design Groups, three EMS sites, and a Supplier.

FIG. 4 illustrates the servers in a preferred embodiment of a Private Exchange Catalog System.

### DESCRIPTION OF THE INVENTION

The Bill of Material, BoM, and the Approved Manufacturing List, AML, are two critical documents that must be released by a design group to a manufacturing group. Both documents use item identifiers, part numbers. The AML maps the part numbers of the design group to the part numbers of suppliers. The manufacturing group may require different supplier part numbers because of manufacturing equipment and local supply base requirements. The manufacturing group may have their own part number set and the BoM and AML may need to be transformed into these part numbers. The design group may have conflicts caused by a part number with multiple AML's. And, there may be errors in the AML caused by manual input. In addition, the multiple sites of the EMS may be seen by the OEM and suppliers as multiple companies rather than one EMS. The present invention, Private Exchange Catalog System, will help solve these issues. The present invention provides a private exchange with a catalog describing

1. An item, and for the item:

2. The part number used by the private exchange,

3. The part number provided by each OEM design group,

4. The part number used by each EMS site,

5. The AML provided by each OEM design group (mapping the OEM design group part number to suppliers and supplier part numbers),

6. The AML used by each EMS site (mapping the EMS site part number to suppliers and supplier part numbers)

7. An item family identifier for aggregation of demand and purchasing.

The present invention provides processes for

1. Mapping each OEM design group part number to the private exchange part number,

2. Mapping the OEM BoM and AML to a Private Exchange BoM and AML,

3. Mapping the private exchange part number to the EMS site part number,

4. Mapping the Private Exchange BoM and AML to an EMS site BoM and AML,

5. Identifying issues and errors with the OEM design group AML and mapping to the private exchange AML, including identifying and managing new part numbers created by the OEM design group and new part numbers created by the private exchange to resolve OEM design group AML issues,

6. Creating the EMS site AML to satisfy the site equipment and local supplier requirements and send the information needed at the EMS site to create a new part numbers with an AML or to update an existing AML to respond to a change from the OEM, EMS supply base management, or the supplier.

7. Providing for purchase orders that require an AVL part number,

8. Identifying and processing updates from supplier catalogs,

9. Providing a commodities catalog and part number to substitute the OEM part number with an EMS commodity part number.

10. Providing a central purchasing order interface to the suppliers with the ability to aggregate the purchasing volumes of related items and other supplies base benefits.

In addition, processes for initializing these processes using information in the current systems are provided.

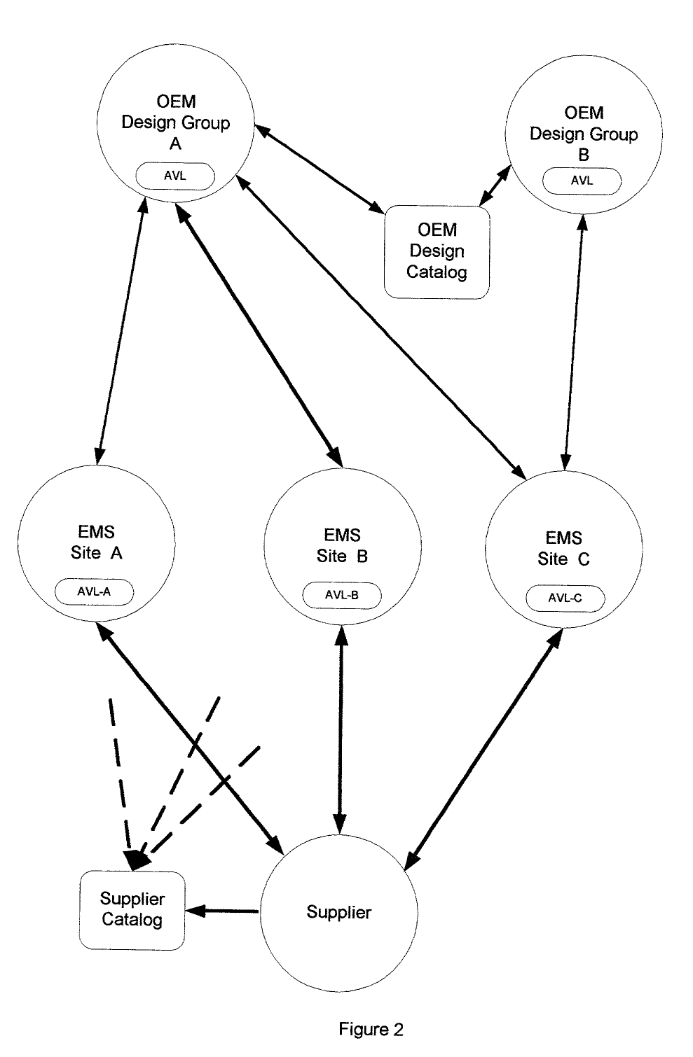

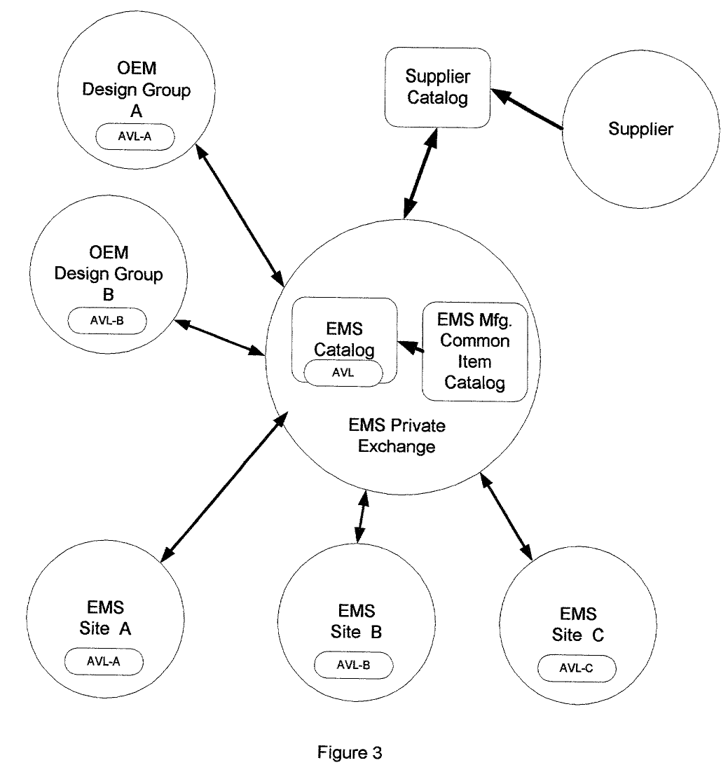

An EMS private exchange is illustrated in FIG. 3 where two OEM design groups, a supplier, and three EMS sites are connected. Compare FIG. 3 with FIG. 2 and note that the private exchange simplifies the interconnection topology in that each OEM design group, EMS site, and supplier need only connect to the EMS private exchange rather than the point-to-point connections among them in FIG. 2. Much of the AML and BoM processing that was done at the EMS sites is now done at the EMS private exchange. The objective is to provide the benefits without materially changing the systems, data formats, or other processes at the EMS sites. Each EMS site will now see “clean” AML and BoM data that are in the EMS site part numbers, identification of new items and information that need to be added to the EMS site systems, the supplier information in the AML matching the EMS site requirements, the EMS site purchasing transactions passed to the supplier with the information required by the supplier to deliver the correct items but with aggregation and other supply benefits for the EMS

Overview of the Processes.

The OEM provides the EMS with a BoM for each product to be manufactured. The OEM may provide an AML with each BoM or may provide the AML independent of the BoM. An Incremental changes to the product or to the AML may be provided by the OEM. Thus, the OEM may be sending the AML to the EMS on a frequent basis. The AML sent by the OEM may have errors and may not reflect the requirements of the equipment and the local supply base. To prevent reprocessing the entire AML with each release, only changes in the AML are processed. Two copies of the AML are kept: 1) the AML as sent by the OEM and 2) a working AML where the supplier and supplier part numbers have been corrected and validated. When an AML is received, it is compared with the previously sent AML to identify changes. The changes identify potential changes to the working AML. When the working AML is changed and validated, the AML received replaces the previously sent AML.

The BoM sent by the OEM has OEM part numbers. The OEM BoM part numbers are converted to the EMS Private Exchange part numbers using a conversion table. If an OEM part number in an OEM BoM is not in the conversion table, then a new EMS Private Exchange part number is created by adding the OEM part number and EMS Private Exchange part number to the conversion table and adding the AML as sent for the new part.

When a BoM is sent to an EMS site. The EMS Private Exchange part numbers are converted to the EMS site part numbers. If an EMS site part number is not in the conversion table, then a new EMS site part number is created by assign the EMS Private Exchange part number and EMS site part number to the conversion table and adding the working AML for the EMS site.

The OEM design groups may not have good configuration control on their part numbers. An OEM part number may have two or more AML's. When this is identified, a second EMS Private Exchange part number is created so that each part number has only one AML. When an OEM BoM is converted to EMS Private Exchange part numbers and an OEM part number has multiple EMS Private Exchange part numbers, one must be selected to be the translated EMS Private Exchange part number.

Part Number Mapping

The related patent application disclosed a Process And Transformation Private Exchange where among the functions taught is the transformation of a first part number to a standard part number followed by the transformation of the standard part number to a second part number. If there are N senders, each with a different part number set, and M recipients, each with a different part number set, a point-to-point solution would require N×M part number transformation processes. With the Process and Transformation Private Exchange, only N+M part number transformation processes are required. The part number is used to reference and tie together all of the information related to an item. The requirements for a part number are that it be unique for the item and the length in characters be useable in all of the systems and processes that use the part number. There may additional benefits in the selection of the part number format such as ease of sorting the part numbers so that certain characteristics are easily observable. For an EMS, it is desirable that the part numbers of an OEM cluster together when sorted, that the OEM part number be easily recognizable, that items that have a tight relationship appear in a sorted list close together. Many EMS companies have adopted a part number structure that appends a prefix to the OEM part number. The prefix is a three or four character string assigned to the OEM. For example, OEM A is assigned the prefix “OEMA” and the EMS generates the EMS representation of OEM A part numbers by appending this prefix. The OEM A part number 1234-5678 becomes OEMA1234-567. This part number is unique since only part numbers from OEM A will have the prefix OEMA and OEM A has assigned the OEM A part numbers to that they uniquely identify the associated item. The association of the OEM A part number to the EMS part number is apparent: just remove the prefix. A sorted list will cluster the part numbers of OEM A.

Non-Unique Use of Part Numbers

There will be cases where OEM A does not have a unique part number for each unique item. Recall the case where a local design group changes the AML of an item and the OEM AML still has the original AML. In this case, the item used by the local design group must have a different part number from the part number used by the other OEM design groups. These two items are closely related in that they only differ in their AML and the difference may only for a period of time while the AML issues are resolved. These “flavors” of an item require different part number. One solution is to append a suffix to the EMS part number to distinguish the part numbers. In the example for OEM A and part number 1234-5678. The local design group modifies the AML and still uses part number 1234-5678. The EMS distinguishes this by adding a suffix, %P for instance for a prototype use, so that the two part numbers would be: OEMA1234-5678 for the “normal” OEM item and OEMA1234-5678%P for the local design group usage. OEMA1234-5678%P is a new item and requires that an item master, AML, and other information be created just as with any new part. The AML for OEMA1234-5678%P is distinct from the AML for OEMA1234-5678. The BoM's that use OEM A part number 1234-5678 must now be examined to insure that the correct part number is used. That is, OEMA1234-5678%P is used for the BoM of the prototype product and OEMA1234-5678 used for all other BoM's. The invention discloses the processes to insure the correct part number is use. It is suggested that the prefix and suffix mechanism be used for mapping the OEM part numbers to the part numbers of the private exchange. The private exchange part number can be also generated by the use of a sequential number generator, a counter, where each new part that needs a new part number is assigned the next available number and the counter is incremented. This will assure that each part number is unique. However, the association of the OEM part number to the EMS part number would require a set of tables that map this information. While this is quite workable, in fact some of the EMS sites will have this mapping mechanism, the ease of translation and sorting will be missing. Essentially, the EMS part number will be a pointer into a table with the OEM part number and associated information. All of the processing will be done on the table information.

A mechanism for mapping the OEM part number to the EMS private exchange part number is provided. A mechanism for assigning a part number with a closely related AML is provided. The process for identifying this situation and managing these part numbers will be disclosed in the AML mapping and validation processing and BoM mapping processing.

The private exchange to EMS site part number map could use the same mechanism that is used by the EMS site to map the OEM part number to the EMS site part number. The new part generation can also be adapted to the EMS private exchange where either the EMS private exchange generates the new part number or the new item is identified and passed to the EMS site system where the new part number is generated and passed back to the EMS private exchange. The process for identification of new will be disclosed.

Commodity Part Number

The mapping of OEM part number to EMS part number is to facilitate the separation of inventory by OEM so that issues such as inventory liability and continuity of supply can be tracked and resolved. If inventory liability and supply are not issues and the EMS would like to have the advantages of single bin stocking of the same part, then a commodity part number can be used for all OEM's. The commodity part number is created by the EMS and has an AML.

The commodity part number must conform to the structure of the private exchange part number so that it cannot accidentally mimic an OEM part number. An example of an EMS commodity part number with a prefix: EMSC123456, where the prefix is EMSC for EMS commodity. Since commodities can have “flavors”, the suffix can be used to create the separation. The commodities are in a catalog much like that of a supplier so that the EMS engineers can find the matching commodity so that it can be substituted in the BoM.

EMS Designed Assemblies and Components

The EMS may have design group that create assemblies with components that need part numbers. Each organization may be working independently and created independent part number systems. These organizations should be treated like OEM design groups and assigned a four-character prefix. An example: EMSD123456 for a component from an EMS design group that has part number 123456.

AML Supplier Name

The OEM AML maps the OEM part number to a supplier name and supplier part number. The supplier name may be inconsistent within the OEM AML or with the EMS supplier name. For example, the OEM AML may use “Tex. Ins.”, “T.I.” of “TI”, for the name of Texas Instruments. The supplier name must be mapped to a consistent reference so that systems can process the AML. Two tables provide this function. The first table, Table 12, maps the set of an OEM spelling of a supplier to a standardized EMS Private Exchange spelling. The second table, Table 13, maps the standardized spelling to the EMS site spelling. If an entry is not found in these tables, then a new entry is added to these tables for the new supplier or the new OEM name for an existing supplier. Note that these tables have the OEM as a qualifier since the spelling of supplier names are usually consistent within a design organization.

BoM Processing without AML

When a BoM source like the OEM sends a BoM, the OEM BoM is translated to the EMS Private Exchange Format by translating each part number in the OEM BoM to the corresponding EMS Private Exchange Part Number using Table 9. The translated BoM can be stored in the EMS Private Exchange. The translation could have a loop that processes each of the OEM part numbers in the BoM. Care taken is for the processing of the OEM part numbers that have multiple part numbers because of AML and other differences. A user screen is provided to select the appropriate part number. Or if the OEM part number does not have an EMS Private Exchange part number which implies that this is a new part.

For 1=1 to number of OEM part numbers;

Temporary Part Number=SELECT EMS Private Exchange Part Number FROM OEM Part Number and EMS Private Exchange Part Number Map WHERE OEM Code=“OEM prefix string” AND OEM Part Number=“OEM Part Number (1)”;

IF the SELECT does not return a part number (NULL) then call New EMS Private Exchange Part Number process;

IF the SELECT returns multiple EMS Private Exchange Part Numbers THEN provide a user screen to select one of the alternatives and Temporary Part Number=selection;

EMS Private Exchange Part Number (I)=Temporary Part Number

Next I

TABLE 9
OEM Part Number and EMS Private Exchange Part Number Map

| | | EMS Private | |
|---|---|---|---|
| OEM | OEM | Exchange | |
| Code | Part Number | Part Number | Description |
| OEMA | 1234-5678 | OEMA1234-5678 | PLA, gates = x |
| OEMA | 1234-5678 | OEMA1234-5678%P | PLA, gates = y |
| OEMA | 1234-5679 | OEMA1234-5679 | Microprocessor |

EMS Private Exchange New Part Number Process

The New Part Number Process creates entries into the appropriate tables in the EMS Private Exchange. The information needed at an EMS site to create the new part number in the EMS site systems is generated in the Site New Part Number Process. The key tables are Table 14 Received AML and Table 9 OEM Part Number and EMS Private Exchange Part Number Map. Table 14 entries are obtained from the OEM AML. Searching Table 10 EMS Commodity Catalog uses the part number description to determine if the part is an EMS commodity. If there is a match on the description, then the commodity part number is used. If there isn't an OEM AML entry for the OEM part number, then the EMS Commodity Catalog is searched for a match against the part description. If there is a match, the commodity part number is used. If not, then the OEM interface person is called to ask what should be done. If a commodity part number is used, the AML entry in the Working AML is set to indicate the EMS as the supplier and the commodity part number as the supplier part number.

TABLE 10
EMS Commodity Catalog

| Commodity | |
|---|---|
| Part Number | Item Description |
| EMSC1234567 | Capacitor, Tantalum, pkg = x |
| EMSC1234568 | Capacitor, Tantalum, pkg = y |

When a product is released, sent, to a site, the BoM is translated from the EMS Private Exchange Part Numbers into the site part numbers. The translation loop is similar to the translation of the OEM BoM to EMS Private Exchange Part Numbers. Table 11, EMS Site and EMS Private Exchange Part Number Map is used SELECT EMS Site Part Number WHERE EMS Site=EMS Site code AND EMS Private Exchange Part Number=UEMS Private Exchange Part Number from the BoM. If the SELECT does not return a part number, then call the NEW SITE PART NUMBER PROCESS.

TABLE 11
EMS Site and EMS Private Exchange Part Number Map

| | EMS Site | EMS Private Exchange |
|---|---|---|
| EMS Site | Part Number | Part Number |
| SITEA | A123456 | OEMA1234-5678 |
| SITEA | A125672 | OEMA1234-5678%P |
| SITEA | A123459 | OEMA1234-5679 |

Site New Part Number Process

The New Part Site Number Process creates entries into the appropriate tables in the EMS Private Exchange. The key tables are Table 15Received AML and Table 11 OEM Part Number and EMS Private Exchange Part Number Map. Table 15 entries are obtained from the Table 14 Received AML where the appropriate site AML entry is entered. The supplier part is obtained from the supplier catalog where the part number matches the requirements of the manufacturing equipment and the local supply base. Much of this is a semi-automated process using the supplier catalog on the Web, or CD's, or through third party supplier information providers. Once the site AML is created, the new part process is used at the site to create a record called the “Item Master” in the site ERP system. The site part number may be assigned using the EMS Private Exchange Part Number or the site ERP system or other site system may generate the site part number. The site part number is entered into Table 11 so that the site part number can be used for the rest of the BoM translation process.

AML Processing without BoM

The OEM may send an AML without a BoM. The strategy is to process only changes to the AML. That is, process added, modified, and deleted supplier parts. Saving the most recent AML entries sent by the OEM and comparing there with the current AML entries detect changes. AML entries with changes are processed at both the EMS Private Exchange level and at the affected site levels. Since there are AML entries only for OEM part numbers in the OEM Part Number and EMS Private Exchange Part Number Map, only the OEM AML entries for parts used in the EMS Private Exchange will be tested for changes. Thus, if the OEM sends their entire AML, only the part numbers that affect the EMS Private Exchange are processed. Each entry in the OEM AML is tested by using SELECT Supplier Name; Supplier Part Number FROM Received AML WHERE OEM=OEM code AND OEM Part Number=OEM Part Number in the AML. If the SELECT returns NULL then the OEM Part Number is not used and the rest of the entry is ignored. If the SELECT returns one or more records, the records are compared with the current OEM AML entries. If there are differences, these are noted for further processing. The current OEM entries replace the entries in the Received AML. The further processing may simply be a user screen where the information is displayed and the user makes the corrections and sends the corrections to update the Working AML. The user may use the supplier web site, CD, or third party information source to find the supplier part number that meets the site requirements for an added or modified supplier and supplier part number. The user function may be automated where a program performs much or all of the modification and validation functions. The Index field for a row in the Received AML ties it to the rows in the Working AML Tables that correspond to the OEM supplier and supplier part number entry. This permits identification of rows that are affected by a change in the OEM AML.

If there are two (or more) EMS Private Exchange Part Numbers corresponding to one OEM part number, then the OEM interface person should be contacted to assure that the correct AML is tested and updated. The EMS part number without the suffix is most likely the one in the OEM AML but this needs to be verified. The AML may also signify that the suffixed part is no longer used and should be removed. The OEM interface should provide this information.

TABLE 12
OEM Supplier Name and EMS Private
Exchange Supplier Name Map

| | OEM | EMS Private Exchange |
|---|---|---|
| OEM | Supplier Name | Supplier Name |
| OEMA | T.I. | Texas Inst. |
| OEMA | Tex. Ins. | Texas Inst. |
| OEMA | TI | Texas Inst. |

TABLE 13
EMS Site Supplier Name and EMS Private
Exchange Supplier Name Map

| | EMS Site | EMS Private Exchange |
|---|---|---|
| EMS Site | Supplier Name | Supplier Name |
| SITEA | Tex. Ins. | Texas Inst. |

TABLE 14
Received AML

| | OEM Part | OEM Supplier | OEM Supplier | | EMS Private Exchange |
|---|---|---|---|---|---|
| OEM | Number | Name | Part Number | Index | Part Number |
| OEMA | 1234-5678 | TI | 7450321-S | 98765 | OEMA1234-5678 |
| OEMA | 1234-5678 | Mot. | 7450456 | 98766 | OEMA1234-5678 |
| OEMA | 1234-5678 | National | 7450332 | 98767 | OEMA1234-5678 |
| OEMA | 1234-5678 | TI | 7450321-S | 98780 | OEMA1234-5678%P |

TABLE 15
Working AML

| | EMS Site | | Supplier | | | | |
|---|---|---|---|---|---|---|---|
| EMS | Part | Supplier | Part | | Item | AVL | Supplier |
| Site | Number | Name | Number | Index | Family | Flag | Update |
| SITEA | A123456 | Tex. Ins. | 7450321-TR | 98765 | 4567 | | 6/02 |
| SITEA | A123456 | Motorola. | 7450456-TR | 98766 | 4567 | OEM | 5/02 |
| SITEB | OA1234-5678 | Tex. Ins. | 7450321-B | 98765 | 4567 | | 6/02 |
| SiTEA | A125672 | Tex. Ins. | 7450321-TR | 98780 | 4567 | | 6/02 |

BoM and AML Processing

The OEM may release a BoM with an AML. As each BoM part number is processed, the OEM AML is compared with the entries in Received AML Table to detect any changes. If there is a difference, the OEM interface person is asked if the change is to all uses of the OEM part number or just for this particular BoM. If for all uses, then the Working AML is updated to reflect the changes. If the change is only for this BoM, then a suffixed part number is created and a new AML entry is created in both the Received AML and the AML as Modified and Validated with the suffixed EMS Private Exchange Part Number in the EMS Private Exchange Part Number field. As an example, OEM A sends a BoM and AML where the OEM part number 1234-5678 has an AML that has only the TI part number and not the Mot and National part numbers. The AML is compared with the AML entries for OEM A part number 1234-5678 in Table 14. (before the bottom entry was made) and the difference is detected. OEM A will be building the product at EMS site A so the change is sent to an AML user at EMS site A. The AML user determines that this is a new usage of OEM A part number 1234-5678 and a new part number needs to be created. The new EMS Private Exchange part number is assigned as OEMA1234-5678%P and the entry is made in Table 14, AML as Received (the bottom entry in the illustration). The entry is also assigned a unique index number (98780) to tie it to the entry in Table 15, the AML as Modified and Validated Table. The EMS site A part number is assigned (A125672) and the orderable part number and other information including the index number is entered into Table 15 (bottom entry in the illustration). If OEM A sends another AML that contains part number 1234-5678, the comparison will be made against the AML entries of both EMS Private Exchange part numbers.

Site-to-Site Transfer

The EMS Private Exchange holds all of the BoM's and AML in corrected form. All new product releases, engineering changes, etc. are first applied to the BoM and AML in the EMS Private Exchange and then released to the EMS sites that are affected by adapting the changes to the EMS site part numbers. To transfer the information from EMS site A to EMS site B is done by releasing the BoM and AML to EMS site B.

AVL Flag

It may be necessary to send the OEM part number or the EMS part number in the order to the supplier rather than the supplier part number. The AVL Flag field can be set to “OEM” if the OEM part number is to be used to order the item, or “EMS” if the EMS part number is to be used. The AVL Flag field permits a part to be ordered using the appropriate part number depending on the relationship with the supplier.

Purchase Order Processing

In the prior art, the EMS site orders were sent directly to the suppliers and the EMS did not have global visibility of all of the orders and could not aggregate for example the total volume purchased from a particular supplier. Also in the prior art is the concept of a central exchange for purchasing transactions to provide a single interface to the suppliers. However, it was difficult to aggregate or extract global information because the part numbers are the orderable part number that includes the carrier and regional differences and the part number in the transactions may not readily identify that a set of purchases are to be aggregated. The Item Family Identification field can be used to relate part numbers by placing the same identifier, “ID”, in this field for the selected part numbers. A SELECT query with WHERE=“ID” will return all part numbers that are related. This can be used for, instance, to aggregate purchases of related part numbers where an Item Family counter with the “ID” is used for aggregation. As each purchase transaction is processed, the part number in the transaction is used to query the AML as Modified and Validated table to return the Item Family Identification ID and the ID is used to identify the appropriate counter to increment with the quantity in the order.

The strategy is to send to each EMS site the exact part number needed to order the desired item so the EMS site systems will embed this in the purchasing transactions. The EMS Private Exchange will provide global visibility to all of the purchasing transactions with the suppliers. However, if an EMS site system cannot send the correct part number, the EMS Private Exchange can be used to translate the purchase order part number to the part number needed by the supplier.

The EMS Private Exchange Catalog provides the cross-reference tables for each OEM part number to each EMS site part number. The EMS global supply base team can decode the inventory and order position of each EMS site with this cross-reference table. In the past, these tables were difficult to maintain because the EMS site part number maps were kept at the site and in forms that were unique to the site. The EMS Private Exchange Catalog provides the mechanism to keep the cross-reference table current, accurate and available because of the central point topology.

Supplier Catalog Updates

Table 15, the Working AML contains the orderable part number from the suppliers. These part numbers may change; items may be replaced with newer items; etc. The suppliers send this information to their customers as letters, e-mail, etc. Their customers do not notice many of these notifications of changes and problems can arise. The Private Exchange Catalog System can receive the change notices from the suppliers and update the Working AML supplier part number information. The supplier usually provides a mapping of the old part number to the new part number. The suppliers also provide warning ahead of time about changes and these can be inserted into the Working AML table in the Supplier Update field. As an example in Table 15, the Supplier Update field contains a date, “6/02” indicating that the next update is expected during June of 2002. Additional field for alternate part numbers, replacement part numbers, etc. can be added. Because of the central point topology, the supplier updates need only be performed once and not at each EMS site.

Initialization

The Private Exchange Catalog System can start as an empty system and add OEM prefixes, EMS site codes, etc. as the use of the system increases. However, it may be desirable to use the system where there are already part numbers, AML's, BoM's, etc. in use. The key tables are Table 14,Received AML and Table 15, Working AML. With the assumption that the part number information in the site ERP or planning system is “good enough” since the current business is operating using it, an initialization process can be proposed. The only information that is usually not available is the AML that was most recently sent by the OEM. The strategy is to populate all of the tables using the information in the EMS site system except for the OEM Suppler Name and OEM Supplier Part Number. These fields will be populated when the OEM sends the next AML. Table 15a is illustrated with the information that can be extracted from the site systems where the EMS site part number is mapped to the current supplier part number and the OEM part number. The Index is created to link the logical entries together.

TABLE 15a
Working AML

| | EMS Site | | Supplier | | | | |
|---|---|---|---|---|---|---|---|
| EMS | Part | Supplier | Part | | Item | AVL | Supplier |
| Site | Number | Name | Number | Index | Family | Flag | Update |
| SITEA | A123456 | Tex. Ins. | 7450321-TR | 98765 | | | |
| SITEA | A123456 | Motorola. | 7450456-TR | 98766 | | | |
| SITEB | OA1234-5678 | Tex. Ins. | 7450321-B | 98765 | | | |
| SITEA | A125672 | Tex. Ins. | 7450321-TR | 98780 | | | |

Table 14a illustrates the information that can be created. Note that the OEM supplier name and the OEM supplier part number are usually not available since most EMS sites will discard this information once they have the part number to order the right parts.

TABLE 14a
Received AML

| | | OEM | OEM | | |
|---|---|---|---|---|---|
| | OEM | Sup- | Supplier | | EMS Private |
| | Part | plier | Part | | Exchange |
| OEM | Number | Name | Number | Index | Part Number |
| OEMA | 1234-5678 | | | 98765 | OEMA1234-5678 |
| OEMA | 1234-5678 | | | 98766 | OEMA1234-5678 |
| OEMA | 1234-5678 | | | 98767 | OEMA1234-5678 |
| OEMA | 1234-5678 | | | 98780 | OEMA1234-5678%P |

When an OEM AML is released for processing, the OEM name is known, the OEM part number is known, however, the OEM supplier Name an OEM supplier Part Number are determine when the first AML is processed. As the OEM AML is processed, the Private Exchange Catalog System will detect a mismatch when these fields are compared to the OEM AML that was received. However, since the fields are blank, the fields from the OEM AML are loaded into the corresponding fields directly. An AML user looks at the AML sent and visually validates that there isn't any changes. The next time the AML is released, it will be compared with these values to detect if a change has occurred.

### DESCRIPTION OF A PREFERRED EMBODIMENT

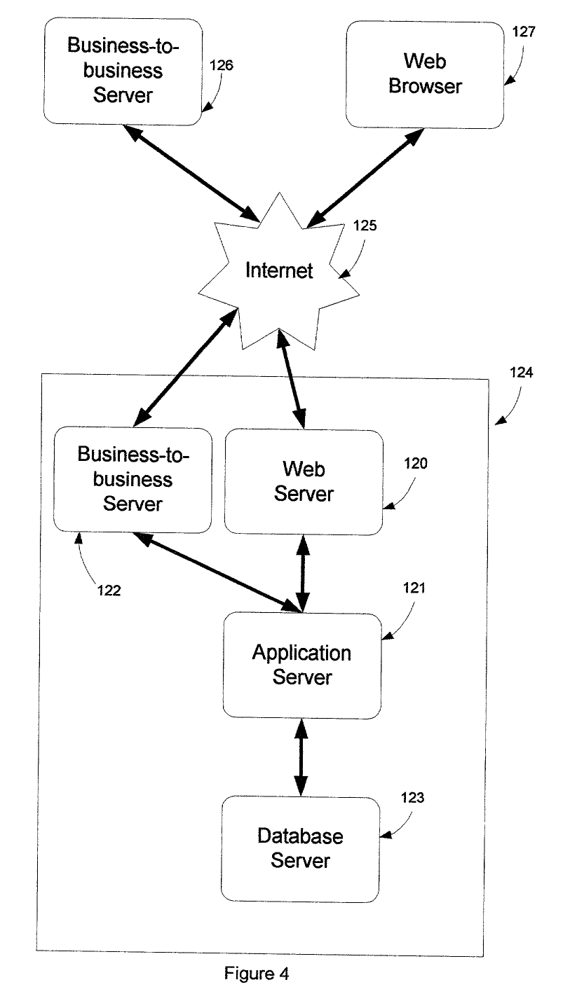

A Private Exchange Catalog system 124, illustrated in FIG. 4, consists of an Application Server 121, a Web Server 120, a Data Base Server 123, and a Business-to-business Server 122. These servers are software programs that execute on server hardware such as a PC from Dell or Compaq, a workstation or network server from SUN or Hewlett Packard, or a mainframe computer from IBM. The server hardware can have operating system services using for example, Microsoft Windows NT, Windows 2000, Sun Solaris, Hewlett Packard HP/UX, IBM O/S 9000, Lenix, etc. The Application Server program may be written in Java, C++, Visual Basic, or a variety of programming languages. Or, the program may be written to execute in an applet or Java bean server such as provided by BEA Web Logic Software or IBM Web Sphere or others. Microsoft Internet Integration Server, Netscape Web Server, or a variety of web server programs may provide the Web server program. Oracle 9i Data Base, IBM DB2, Microsoft SQLServer, or other databases may provide the data base program. Extricity, Neffish, Vitria, are among a set of software providers of Business-to-business server programs. The Business-to-business server 122 may accept RosettaNet protocol, Internet File Transfer Protocol, EDI protocols, or a wide variety of public and private protocols. The Web server and the Business-to-business server connect to the Internet 125. Using the Internet, the Web Server connects to one or more Web clients 127 executing a Web browser, for example, Microsoft Internet Explorer or Netscape Navigator. The Web clients may be workstations, PC's, mainframe terminals, etc. However, a number of web clients are wireless devices such as: PDA's, cell phones, two way pagers, etc.

A program in the Application Server 121 provides the Private Exchange Catalog System functions and uses the Web Server 120 to connect to the Web clients 127, the Business-to-business Server 122 to connect to another Business-to-business Server 126, and the Database Server 123 to store all of the business and process information. The functions of the Private Exchange Catalog System may be defined as process steps in a workflow route. Application Server 121 may be developed with a workflow system such as BEA Web Logic Process Integrator or the Extricity Workflow product. The process steps may be written in Java.

A Bill of Material, BoM, or Approved Manufacturer List, AML, and the requested function are sent as a file by a user at a Web client 127 or from a system through the Business-to-business Server 122. The file from the Web client passes through the Web server 120 to the Application Server 121. A file from the Business-to-business Server 122 transfers directly to the Application Server 121. The Application Server 121 parses the requested function and associates the file with a process such as BoM translation from OEM part numbers to Private Exchange part numbers. The tables with the translation maps, the AML information, BoM's, etc. are stored in Database Server 123. If specified by the process definition, the BoM or AML is sent to the specified user or system. If it is to be sent to a user, the Web Server 120 and Web Client 127 are used. If it is to be sent to a system, the Business-to-business 123 is used.

I claim:

1. A Private Exchange Catalog System and an OEM AML source, both connected to a network, an AML relating an OEM part number to a supplier and supplier part number, wherein the Private Exchange Catalog system is comprised of an Received AML storage containing a previous received AML and a Working AML storage containing the working AML such that when the Private Exchange Catalog system receives an AML from the AML source using the network, the Private Exchange Catalog System:
Compares the received AML with the previous received AML from the Received AML storage,
If different, then
a. The AML changes are identified in the working AML;
b. The working AML changes are made and validated;
c. The modified working AML is stored in the Working AML storage and the received AML is stored in the Received AML.

2. The Private Exchange Catalog System of claim 1, a BoM source also connected to the network, wherein the Private Exchange Catalog System further comprises a part number to Private Exchange part number translation and a BoM storage such that when a BoM source sends a BoM to the Private Exchange Catalog System using the network, the Private Exchange Catalog system
Translates the part numbers in the received BoM to a BoM with Private Exchange part numbers,
If a part number in the BoM has multiple Private Exchange part number translations, then one is selected as the Private Exchange part number,
If a part number in the BoM is not in the part number translation, then a new part number is created in the part number to Private Exchange part number translation and a new AML created and stored in the Received AML storage using the information in the received AML, and
Stores the translated BoM in the BoM storage.

3. The Private Exchange Catalog System of claim 1, an EMS site BoM receiver also connected to the network wherein the Private Exchange Catalog System further comprises a Private Exchange part number to EMS site translation and a BoM storage such that when a BoM is to be sent to the EMS site using the network, the Private Exchange Catalog System
Retrieves the BoM from BoM storage,
Translates the Private Exchange part numbers in the BoM to a BoM with EMS site part numbers and
If a part number in the Private Exchange part number BoM is not in the Private Exchange to EMS site part number translator, then a new EMS site part number is created in the Private Exchange part number to EMS site part number translator, EMS site entries are added to the working AML in the Working AML storage
Sends the translated BoM to the EMS site BoM receiver using the network.

4. The Private Exchange Catalog system of claim 1, a BoM and AML supplier also connected to the network wherein the Private Exchange Catalog system Receives the BoM and AML for the BoM and AML supplier,
Translates the part numbers in the BoM to a BoM with Private Exchange part numbers,
Compares the received AML with the previous AML from the Received AML storage.
If the received AML part number entry does not match the entry in the pervious AML, then the BoM and AML supplier decides either to change the AML using the process of claim 1 or a new part number is created in the part number to Private Exchange part number translation and a new AML created and stored in the Received AML storage using the information in the received AML,
If a part number in the BoM is not in the part number to Private Exchange part number translation, then a new Private Exchange part number is created in the part number to Private Exchange part number translation and a new AML created and stored in the Received AML storage using the information in the received AML
Stores the translated BoM in BoM storage.

5. The Private Exchange Catalog system of claim 1, further comprises a commodity catalog containing item descriptions with corresponding commodity part numbers such that while translating a BoM part number, the description for the part with the BoM part number is used to query the commodity item descriptions and if there is a match, the corresponding commodity part number is substituted for the translated Private Exchange part number.

6. The Private Exchange Catalog system of claim 1, further comprises a supplier update function that updates the supplier part numbers in the AML stored in the Working AML storage based on the supplier provided map of the old supplier part number to new supplier part number.

7. The Private Exchange Catalog System of claim 1, further comprises an initialization function where
The EMS site, EMS part number, Supplier Name, and Supplier Part Number fields of AML stored in the Working AML are initialized from the EMS site system;
OEM part number of the AML stored in the Received AML storage is initialized from the EMS site system;
The OEM code is chosen;
The Private Exchange part numbers of the AML stored in the Received AML storage are generated from the OEM code and OEM part number;
The index field is generated to cross reference the rows in the AML stored in the Received AML storage and the Working AML storage
such that when an OEM AML is received and compared with the previous AML in the Received AML storage, the supplier name and supplier part number fields of the OEM AML are inserted into the supplier name and supplier part number fields of the previous AML and the now modified pervious AML is stored in the Received AML storage as the previous AML.

8. The Private Exchange Catalog System of claim 1, an EMS purchasing system, a supplier fulfillment system, both connected to the network wherein the Private Exchange Catalog System further comprised of an item family counter, where an item family identifier is assigned to each item, such that when an EMS purchasing systems sends a purchasing transaction with a part number and quantity to the Private Exchange Catalog System, the Private Exchange Catalog System uses the part number to obtain the item family identifier for the item represented by the part number and uses the item family identifier to increment the item family counter by the quantity of the item in the purchase order, and the purchase order is sent to the supplier fulfillment system.

9. A Private Exchange Catalog System and an OEM AML sender both connected to a network wherein the Private Exchange Catalog System comprises a working AML and a copy of the previously sent AML with which to compare an AML sent by the OEM AML sender to identify changes, where the changes identify potential changes to the working AML that are made and validated and the received AML replaces the previously sent AML.

10. The Private Exchange Catalog System of claim 9, further comprising an OEM BoM to Private Exchange Catalog System BoM translation where the an OEM part number is mapped to a Private Exchange Catalog System part number such that when an OEM part number has no Private Exchange Catalog System part number a new Private Exchange Catalog System part number is created and when an OEM part number has multiple Private Exchange Catalog part numbers one is selected.

11. The Private Exchange Catalog System of claim 9, further comprising a Private Exchange Catalog System BoM to site BoM translation where a Private Exchange Catalog System part number is translated to a site part number such that when a Private Exchange Catalog System has no site part number, a new site part number is created.

12. The Private Exchange Catalog System of claim 9, further comprising an OEM AML and BoM to Private Exchange Catalog System AML and BoM translation where an OEM part number is translated to a Private Exchange Catalog part number such that when an OEM part number has no Private Exchange Catalog System part number a new Private Exchange Catalog System part number is created and when an OEM part number AML entry is different from the corresponding Private Exchange Catalog AML entry then either the Private Exchange Catalog AML entry is changed or a new Private Exchange Catalog part number and AML entry are created and when an OEM part number has multiple Private Exchange Catalog part numbers one is selected.

13. The Private Exchange Catalog System of claim 9, further comprising a Commodity Catalog and an OEM BoM to Private Exchange Catalog System BoM translation where the an OEM part number is mapped to a Private Exchange Catalog System part number such that the description of the item with the part number is used to search the Commodity Catalog and if a match is found, the Commodity Catalog part number is used as the Private Exchange Catalog part number and when an OEM part number has no Private Exchange Catalog System part number a new Private Exchange Catalog System part number is created and when an OEM part number has multiple Private Exchange Catalog part numbers one is selected.

14. The Private Exchange Catalog System of claim 9, further comprising a supplier catalog update where a Private Exchange Catalog System Working AML supplier part number is updated with the supplier catalog part number.

15. The Private Exchange Catalog System of claim 9, further comprising an initialization function where information from a site system initializes the Private Exchange Catalog System AML except for the supplier and supplier part number sent by the OEM and the supplier and supplier part number are set when an AML is sent by the OEM.

16. The Private Exchange Catalog System of claim 9, further comprising an Item Family counter where each Private Exchange Catalog System part number has an Item Family identifier such that when a purchase order with a site part number and quantity is received, the site part number is used to determine the Private Exchange Catalog System part number Item Family identifier and the Item Family counter for that identifier is incremented by the quantity amount.

17. The Private Exchange Catalog System of claim 9, further comprising a site to site transfer where the BoM and AML for a first site is sent to a second site by transforming the Private Exchange Catalog System BoM and AML to the BoM and AML of the second site.
